(19) United States
(12) Patent Application Publication
(10) Pub. No.: US 2016/0081880 A1
(43) Pub. Date: Mar. 24, 2016

(54) MEDICATION COMMINUTION AND DELIVERY CUP

(71) Applicant: BC0967481, Surrey (CA)

(72) Inventors: Fredrick Maroon Dominy, Phoenix, AZ (US); John Alan Enns, Abbotsford (CA); Valerie Jill Enns, Abbotsford (CA); Aaron Edward Fader, Surrey (CA); Tima Fader, Surrey (CA); Trent George Reynolds, Surrey (CA)

(21) Appl. No.: 14/490,604

(22) Filed: Sep. 18, 2014

(51) Int. Cl. A61J 7/00

(52) U.S. Cl. CPC A61J 7/0007; A61J 7/0046

(57) ABSTRACT

A single-use nesting cup for use with mechanical comminution devices having a spinning drive mechanism for pulverizing pills into powder is disclosed. Each cup has a textured base surface that provides for a more efficient grinding and crushing of pills inserted between two such cups when an upper cup is spinningly brought to bear down on a bottom cup. The textured surface of each cup base has a symmetric three-dimensional wave design with each wave arcing along a curve from an outer cylindrical wall of the cup spiraling in toward a center point of the base of each cup. The crest and troughs of each wave act as grinding edges while the overall symmetric wave design acts to maintain the one or more pills and it's powdered form in the center of the bottom cup.

### FIELD OF THE INVENTION

The present invention pertains to the field of drug delivery and more particularly to the area of comminution of solid medications for improved drug delivery.

### BACKGROUND

Often patients have difficulty swallowing medications in tablet or pill form; however for many medications, this is the only form in which it is available. Also, many pills come with coatings or are otherwise designed to break down after ingestion, but in cases where patients are very young, elderly, and/or ill this break down of medication is disrupted and either occurs much slower than desired or not at all. In order to more easily and effectively administer medications in such cases, pills are often comminuted with a mortar and pestle or other mechanical device that generally crushes and/or grinds the pill between two hard surfaces such as those found in U.S. Pat. No. 7,559,496; U.S. Pat. No. 7,543,770; U.S. Pat. No. 7,427,041; U.S. Pat. No. 6,637,685; U.S. Pat. No. 6,059,209; U.S. Pat. No. 5,067,666; and U.S. Design Patents D433,148 and D545,622. Once the pills are comminuted the powder is generally transferred to a container where it is mixed with fluid or food for administering to a patient.

In order to reduce cross-contamination and material loss, inexpensive single use nesting containers have been used to comminute one or more pills between two contacting bottom surfaces of the nesting containers. These containers can then be separated and the comminuted medication can then be scraped and mixed or suspended in a fluid or food for administering to a patient. There are a number of container designs in the prior art for such purposes including those found in U.S. Pat. No. 7,559,496; U.S. Pat. No. 6,059,129; U.S. Pat. No. 5,553,793; and U.S. Design Patent D620,607.

### SUMMARY OF THE INVENTION

In accordance with the present invention, a single-use nesting cup is disclosed for use with mechanical comminution devices having a spinning drive mechanism for pulverizing pills into powder. The single-use food safe cups each have a textured base surface that provides for a more efficient grinding and crushing of pills inserted between two such cups when an upper cup is spinningly brought to bear down on a bottom cup thereby simultaneously crushing and grinding one or more pills between the base surfaces of the two nesting cups. The textured surface of each cup base has a symmetric three-dimensional wave design with each wave arcing along a curve from an outer cylindrical wall of the cup spiraling in toward a center point of the base of each cup. The crest and troughs of each wave act as grinding edges while the overall symmetric wave design acts to maintain the one or more pills and it's powder form (after comminution) in the center of the bottom cup.

Further in accordance with the present invention, a single-use nesting cup is disclosed having volume graduation markings on the outer cylindrical wall of each cup for indicating the volume of liquid contained when filled up to marked points. This allows for fluids to be measurably added to the cup for directly dispensing medication to the patient without loss of the comminuted material by needing to transfer it to another container. A fluid measurably added to the single-use nesting cup containing a comminuted medication may also contain additional medicinal ingredients and/or may act as a suspending agent to suspend the comminuted medication for easier ingestion. A fluid may also be used to help in providing a more desirable time-release of the comminuted medication's active ingredients taking into consideration the reactivity of other medications being administered to the patient, the patient's overall body chemistry and ability to digest the medication(s).

It will be appreciated that this Summary describes only some of the concepts covered in greater detail in the following Detailed Description and associated drawings. As such, claimed subject matter is not limited to the contents of this Summary.

### BRIEF DESCRIPTION OF DRAWINGS

The drawings illustrate aspects of the invention, and should not be construed as restricting the scope of the invention in any way.

FIG. 1 is a three-point perspective view of the inner surface of an exemplary cup according to the invention.

FIG. 2 is a two-dimensional perspective view looking down at the inner surface of an exemplary cup according to the invention.

FIG. 3 is a two-dimensional perspective view looking down at the outer surface of an exemplary cup according to the invention.

FIG. 4 is a three-point perspective view of the outer surface of an exemplary cup according to the invention.

FIG. 5 is a side elevational view of an exemplary cup according to the invention.

FIG. 6 is two-dimensional perspective view looking down at the outer surface of an alternate embodiment of the invention.

FIG. 7 is a three-point perspective view of the outer surface of an alternate embodiment of the invention.

### DETAILED DESCRIPTION

Unless defined otherwise, all technical and scientific terms used herein have the same meaning as commonly understood by one or ordinary skill in the art to which this invention belongs.

According to one aspect of the present invention, nesting cups are provided for the comminution of pills. The nesting cups are optimally designed for use with mechanical comminution devices having a spinning drive mechanism for pulverizing pills into powder form. Each cup has a textured base surface that provides for an efficient grinding and crushing of pills inserted between two such cups. The textured surface of each cup base has a symmetric three-dimensional wave design with each wave arcing along a curve from the outer cylindrical wall of the cup toward the center point of the base of each cup. In order to pulverize a pill into powder form, two cups are used simultaneously in conjunction with a pill comminution device. A pill is placed in a first, bottom cup. A second, top cup, is then placed on top of the bottom cup containing the pill. In this orientation, the two cups are positioned in a pill comminution device having a spinning drive mechanism. The bottom cup remains stationary while the drive mechanism of the comminution device spins the top cup over the bottom cup in order to simultaneously crush and grind the pill into powder form.

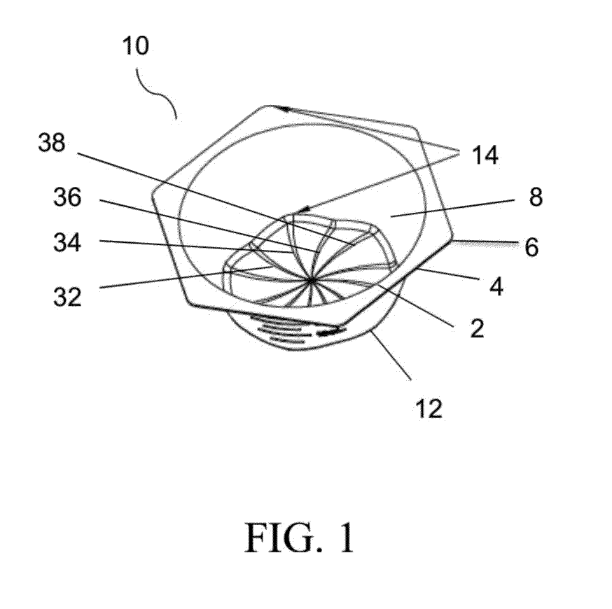

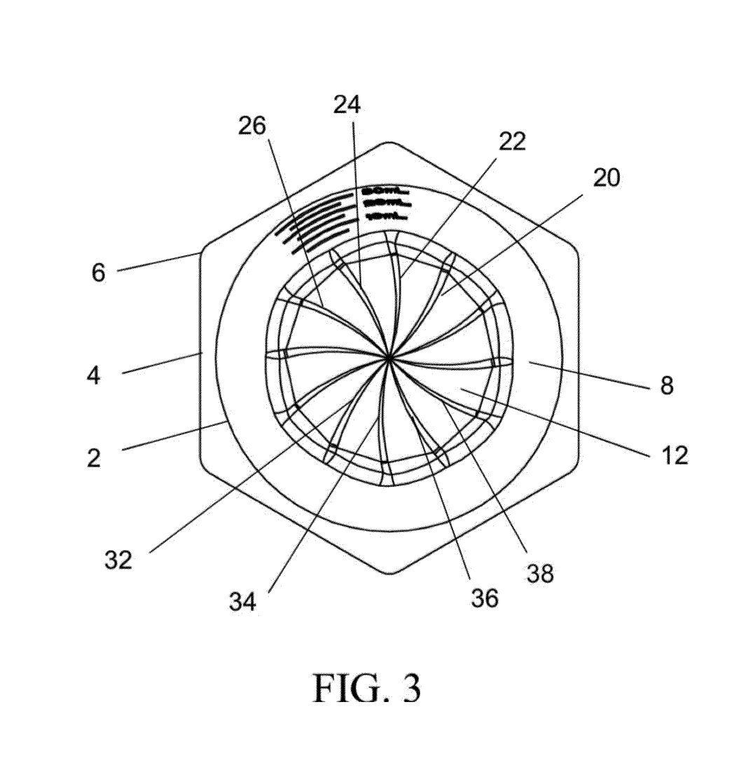

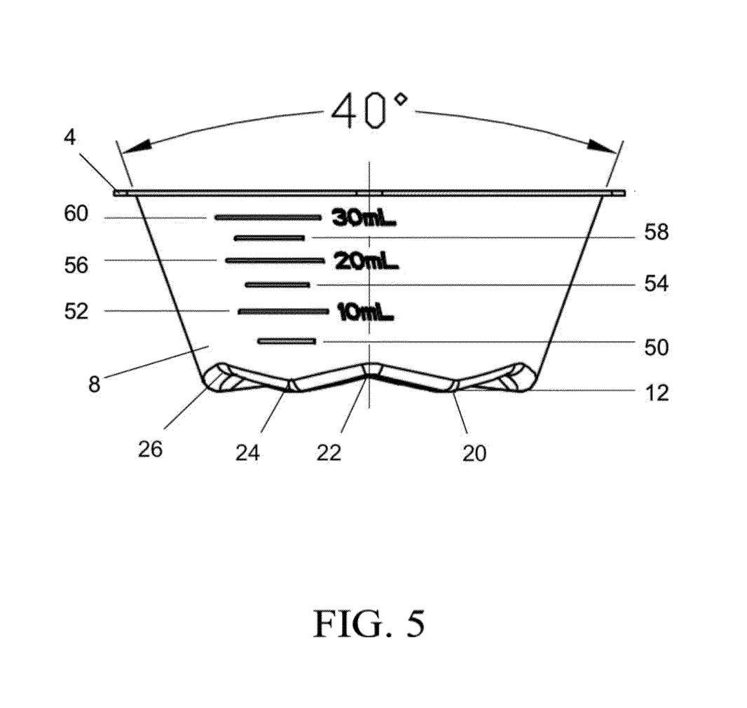

FIG. 1 shows a three-point perspective of an exemplary cup 10 having an open, circular top 2 with a six-sided rim 4 protruding outwardly therefrom. The cup has a tapered, cylindrical shaped wall 8. Further, the cup has a base 12 with a textured surface that simultaneously crushes and grinds pills into powder form when in use as described herein. In a preferred embodiment, the base surface has six symmetrical waves, each wave being widest along an outer edge of base 12 narrowing to a point at the center of base 12. Each wave has an arced crest (see 34 and 38 in FIGS. 1-4 and 22 and 26 in FIGS. 3 and 5) that acts as a grinding edge, curving in a spiral-like path from a high point where cylindrical wall 8 meets outer edge of base 12, to a lower point at the center point of base 12. Additionally each wave has a trough (see 32 and 36 shown on either side of crest 34 in FIGS. 1-4 and 20 and 24 shown on either side of crest 22 in FIGS. 3 and 5). Each trough curves in a spiral-like path from a low point where cylindrical wall 8 meets outer edge of base 12 to the center point of base 12. In a preferred embodiment, each of the six wave crests aligns with one of six projecting rim corners 6 at the crest's outer most point of base 12 as denoted by arrows 14 in FIG. 1.

In order to pulverize a pill into powder form, two cups are used simultaneously in conjunction with a pill comminution device preferably having a spin drive mechanism. A pill is placed in a first, bottom cup. The arced spiral design of the six wave crests all curving down to a center point of the cup's base 12 acts to position the pill placed in the first, bottom cup at the center of the first bottom cup's base 12. A second, top cup is then placed on top of the first, bottom cup containing the pill. In this orientation, the two cups are positioned in a pill comminution device having a spinning drive mechanism. The six-sided rim 4 of cup 10 has six outwardly projecting corners 6 that can act to fix the bottom, first cup in a stationary position in the comminution device. While the first, bottom cup remains stationary, the drive mechanism of the comminution device spins the second, top cup over the first, bottom cup in order to simultaneously crush and grind the pill into powder form. The six wave crests of the first, bottom cup, along with the six wave troughs of the second, top cup, act as grinding edges to efficiently grind the pill placed there between. The arced spiral design of the six wave crests all curving down to a center point of the cup's base 12 acts to keep the pulverized powder in the center of the cup base 12. Although only a single pill being comminuted has been described, more than one pill can be pulverized at the same time with the resulting powder being retained near the center of cup base 12.

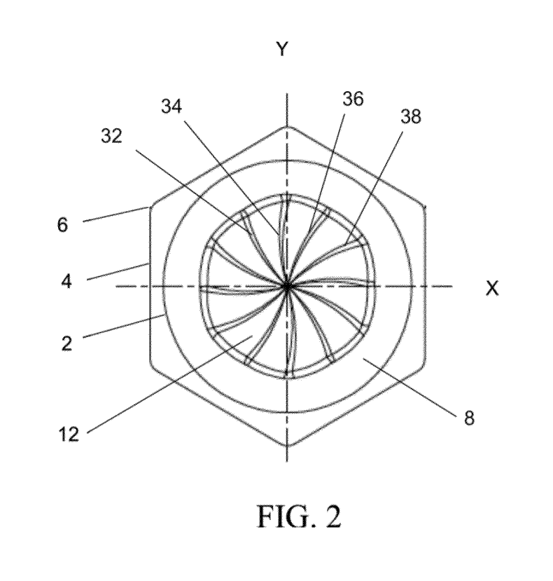

FIG. 2 shows an alternate view of cup 10 with the arced curve wave design of base 12 shown from a perspective view looking directly down into cup 10. In a preferred embodiment, each of the six wave troughs (including 32 and 36) of base 12 meet cylindrical wall 8 of cup 10 at an outer most point, each aligning with a midpoint of a cup rim side 4. Likewise, each of the six wave crests lines up with one of six outwardly projecting rim corners 6 of cup 10 at their outer most points at an outer edge of base 12. For example, wave crest 34 of base 12 meets the cylindrical wall 8 of cup 10 at an outermost point that aligns with a projecting rim corner 6 of cup 10 in FIG. 2.

FIG. 3 is a two-dimensional perspective view of cup 10 looking down at the outer surface of base 12, cylindrical wall 8 and six-sided rim 4 having six outwardly projecting rim corners 6. Wave troughs 20, 24, 32 and 36 and wave crests 22, 26, 34 and 38 are denoted.

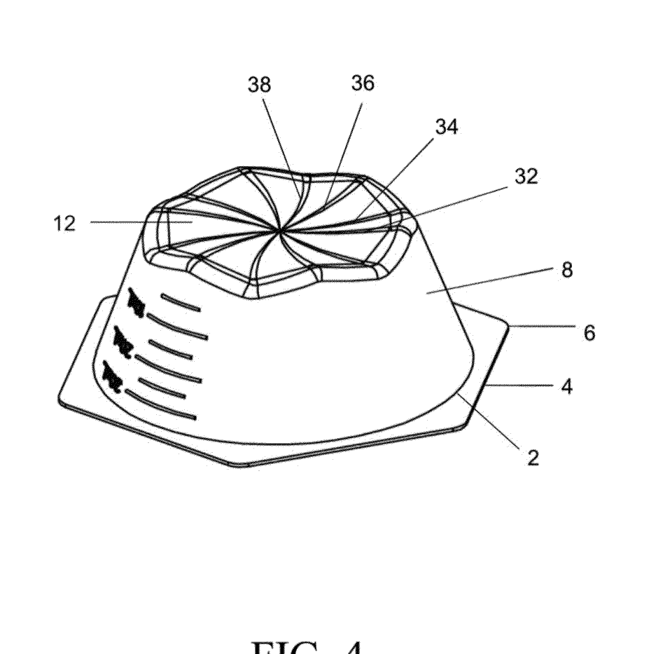

FIG. 4 is a three-point perspective view of the outer surface of an exemplary cup according to the invention. The outer surface of base 12 meets cylindrical wall 8 which angles outwardly to a circular top 2 having a six-sided rim 4 with six outwardly projecting rim corners 6. Troughs 32 and 36 and crests 34 and 38 are denoted.

FIG. 5 shows an exemplary side view of cup 10 with cylindrical wall 8 tapering from rim 4 of the cup to base 12. Also shown are the outer most points at which troughs 20 and 24; and the outer most points at which crests 22 and 26 of base 12 meet cylindrical wall 8. Each of the six wave troughs of cup 10 are formed such that the outer point of each trough will rest on a flat surface when cup 10 is placed facing up on the flat surface. The volume graduation markings 50, 52, 54, 56, 58 and 60 denote the volume of liquid contained when filled up to the marked lines. This allows for fluids to be measurably added to the cup for directly dispensing medication to a patient without loss of the comminuted material by needing to transfer it to another container. A fluid measurably added to the single-use nesting cup containing a comminuted medication may also contain additional medicinal ingredients and/or may act as a suspending agent to suspend the comminuted medication for easier ingestion. A fluid may also be used to help in providing a more desirable time-release of the comminuted medication's active ingredients taking into consideration the reactivity of other medications being administered to the patient, the patient's overall body chemistry and ability to digest the medication(s).

The preferred six symmetrically arcing waves spiraling in toward the center of the base of the nesting cups shown in FIG. 1-5 helps to concentrate the powder in the middle of the cup and keep the powder from migrating outward to the outer edge of the cup while the pill is being comminuted. This allows for a more thorough mixing of the powder when fluid is added to the cup. In alternate embodiments the textured base may have fewer or greater than six waves; however each wave still arcs in a spiral design from an outer edge of the cup base to a center point of the cup base in order to provide grinding edges when a pill is crushed between two such cups and to collect the resulting powder at the center of the cup base.

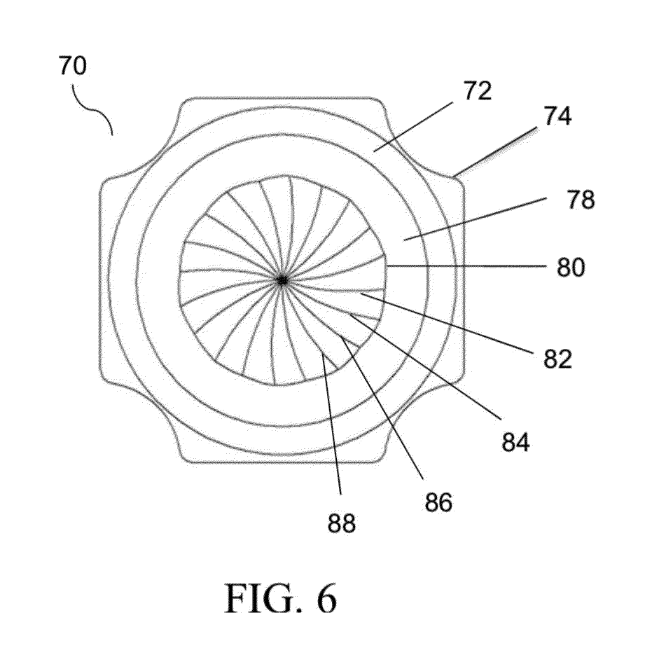

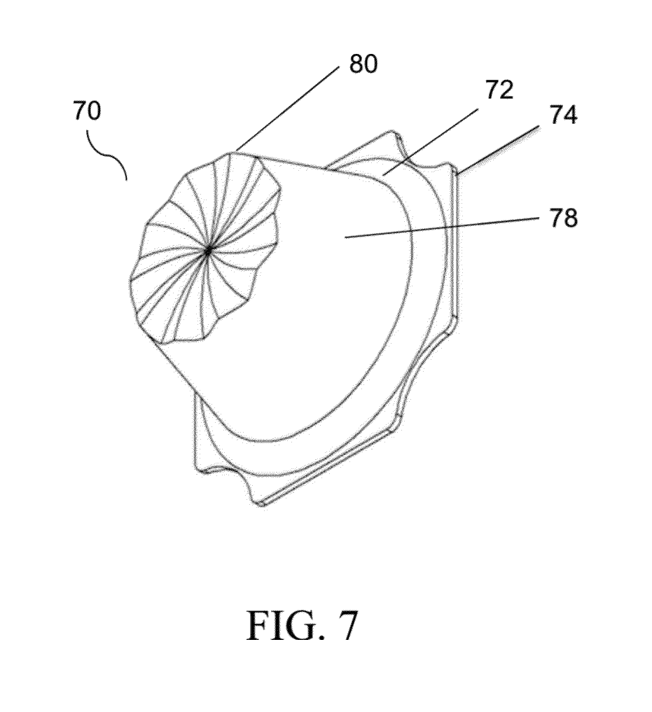

In an alternate embodiment shown in FIG. 6 and FIG. 7, an exemplary cup 70 has an open, circular top 72 with a four-sided rim 4 protruding outwardly therefrom. The cup has a tapered, cylindrical shaped wall 78. Further, the cup has a base 80 with a textured surface that simultaneously crushes and grinds pills into powder form when in use as described herein. In this embodiment, the base surface has ten symmetrical waves, each wave being widest along an outer edge of base 80 narrowing to a point at the center of base 80. Each wave has an arced crest (see 84 and 88) that acts as a grinding edge when used as described herein. The arced crests curving in a spiral-like path from a high point where cylindrical wall 78 meets outer edge of base 80, to a lower point at the center point of base 80. Additionally each wave has a trough (82 and 86 shown on either side of crest 84 in FIG. 6). Each trough curves in a spiral-like path from a low point where cylindrical wall 78 meets outer edge of base 80 to the center point of base 80.

It is important to note the wave design of the textured base of each cup is shown in all the figures spiraling inward toward the center of the base of the cup for a right-hand spin drive comminuting device which spins the upper cup down in a clockwise direction to nest on to a bottom cup that does not rotate. Alternately if a right-hand spin drive comminution device is designed to rotate the bottom cup in an upward motion toward an upper cup that does not rotate, then the wave design would be a minor image of the one shown in the Figures.

The nesting cups are designed to be for single-use and therefore are made from inexpensive food safe polymers such as a polypropylene, polyethylene, polystyrene, polyvinyl chloride, poly(lactic acid), and polycarbonate but other suitable materials may also be used to form the nesting cups.

It is to be understood that the specific design and method of using the cups described herein are exemplary in nature, and that these specific embodiments or examples are not to be considered in a limiting sense, because numerous variations are possible. For example the rim of each cup may be extended outwardly on one corner to form a handle in which to grip and/or label the contents of the cup. A spout may be formed on a rim for easier pouring. It should be understood that the disclosed embodiments are illustrative and not restrictive. Variations to the disclosed embodiments that fall within the metes and bounds of the claims, now or later presented, or the equivalence of such metes and bounds are embraced by the claims.

We claim:

1. A pill comminution device comprising an interchangeable nestable pair of cups, a first cup and a second cup, each cup having
a. an open circular top;
b. a cylindrical wall tapering inward from the circular top to a textured base;
c. said textured base having symmetric three-dimensional waves, with each wave arcing along a curve from an outer edge of the base toward a center of said base;
said textured base of each cup having sufficient rigidity to crush a pill placed between a nested said first cup and said second cup when a compressive force is brought to bear on said cups.

2. The device of claim 1, wherein said compressive force is a rotational compressive force that spins said second cup down onto a stationary said first cup wherein the textured cup bases grind said pill placed there between.

3. The device of claim 1, wherein said compressive force is a rotational compressive force that spins said first cup up to a stationary said second cup wherein the textured cup bases grind said pill placed there between.

4. The device of claim 1, wherein each wave of said textured cup base is widest along an outer edge of the base, narrowing to a point at the center of the base.

5. The device of claim 4, wherein each wave has an arced crest forming a grinding edge, said crest curving in a spiral-like path from a high point where the cylindrical wall of the cup meets an outer edge of the cup base, to a lower point at the center of the cup base.

6. The device of claim 5, wherein each wave has a trough forming a grinding edge, said trough curving in a spiral-like path from a low point where the cylindrical wall meets an outer edge of the base to the center of the base.

7. The device of claim 1, wherein at least six symmetric three-dimensional waves form the textured base of each cup.

8. The device of claim 1, wherein at least ten symmetric three-dimensional waves form the textured base of each cup.

9. The device of claim 5, wherein said open circular top of each cup also has a rim protruding outwardly therefrom.

10. The device of claim 9, wherein each cup rim has multiple symmetrically sized sides forming projecting rim corners where each of two sides meet; said wave crests each aligning with one of the projecting rim corners at a crest's outer most point where the cup's base meets the cup's cylindrical wall.

11. The device of claim 10, wherein the rim is six sided.

12. The device of claim 10, wherein each cup has volume graduation markings on the cylindrical wall of each cup for indicating the volume of liquid contained when filled up to marked points.

13. A cup having
a. an open circular top;
b. a cylindrical wall tapering inward from the circular top to a textured base;
c. said textured base having symmetric three-dimensional waves with each wave arcing along a curve from an outer edge of the base toward a center of said base;
d. said textured base having sufficient rigidity to crush a pill placed between two such nested cups when a compressive force is brought to bear on said cups.

14. The cup of claim 13, wherein each wave of said textured cup base is widest along an outer edge of the base, narrowing to a point at the center of the base.

15. The cup of claim 14, wherein each wave has an arced crest forming a grinding edge, said crest curving in a spiral-like path from a high point where the cylindrical wall of the cup meets an outer edge of the cup base, to a lower point at the center of the cup base.

16. The cup of claim 15, wherein each wave has a trough forming a grinding edge, said trough curving in a spiral-like path from a low point where the cylindrical wall meets an outer edge of the base to the center of the base.

17. The cup of claim 15, wherein a rim protrudes outwardly from said open circular top; said rim having multiple symmetrically sized sides forming projecting rim corners where each of two sides meet; said wave crests each aligning with one of the projecting rim corners at a crest's outer most point where the cup's base meets the cup's cylindrical wall.

18. The cup of claim 13, wherein at least six symmetric three-dimensional waves form the textured base of each cup.

19. The device of claim 13, wherein each cup has volume graduation markings on the cylindrical wall of each cup for indicating the volume of liquid contained when filled up to marked points.

20. A method of comminuting a pill, wherein an interchangeable nestable pair of cups is provided, a first cup and a second cup, each cup having
a. an open circular top;
b. a cylindrical wall tapering inward from the circular top to a textured base;
c. said textured base having symmetric three-dimensional waves, with each wave arcing along a curve from an outer edge of the base toward a center of said base; wherein
i. each wave is widest along an outer edge of the base, narrowing to a point at the center of the base;
ii. each wave has an arced crest forming a grinding edge, said crest curving in a spiral-like path from a high point where the cylindrical wall meets an outer edge of the base, to a lower point at the center of the cup base; and
iii. each wave has a trough forming a grinding edge, said trough curving in a spiral-like path from a low point where the cylindrical wall meets an outer edge of the base to the center of the base;
said textured base of each cup having sufficient rigidity to crush and grind a pill placed between a nested said first cup and said second cup as a rotational compressive force is brought to bear on said second cup thereby advancing said second cup spirally into said first cup thereby turning said pill into a powder.
